(19) United States
(12) Patent Application Publication
(10) Pub. No.: US 2016/0115722 A1
(43) Pub. Date: Apr. 28, 2016

(54) Gate Latch

(71) Applicant: John G. Vasilion, Wilmette, IL (US)

(72) Inventor: John G. Vasilion, Wilmette, IL (US)

(21) Appl. No.: 14/525,834

(22) Filed: Oct. 28, 2014

(51) Int. Cl. E05C 19/02

(52) U.S. Cl. CPC E05C 19/02

(57) ABSTRACT

A latch for first and second members is described where the first member is stationary and the second member rotates about an axis toward the first member to a closed position and away from the first member to an open position. The latch includes a keeper assembly mounted on the first member and a keeper. The latch also includes a catch assembly mounted on the second member and including a pivotable catch such that when the second member rotates about the axis toward the first member, the catch engages the keeper to releasably secure the first member to the second member. The latch may be provided with two handles.

### BACKGROUND

The present invention relates to a latch to releasably secure a moving member to a stationary member. The latch is suitable to releasably secure a swingable gate to a stationary gate post or other stationary object.

Many gate latches include a catch on the swingable gate that engages a receiving member or keeper provided on the gate post. These types of gate latches, however, suffer a common disadvantage; the catch provided on the gate must cooperate with the keeper provided on the post. Over time and under changing weather conditions, the distance (or space) between the post and the gate often changes. As a result of these changes, the catch is not capable of and does not cooperate with the keeper so that the gate cannot be secured to the post.

The present invention solves that problem and provides a number of advantages not previously provided with known latches.

### SUMMARY

In one embodiment, a latch is provided for first and second members, where the first member is stationary and the second member rotates about an axis toward the first member to a closed position and away from the first member to an open position. The latch includes a keeper assembly and a catch assembly. The keeper assembly is mounted on the first member and includes a keeper. The catch assembly is mounted on the second member and includes a pivotable catch wherein when the second member rotates about an axis toward the first member; the catch engages the keeper to releasably secure the first member to the second member. The first member has a first surface and the second member has a first surface, which is opposed to and spaced from the first surface of the first member when the first and second members are in a closed position.

In one embodiment, a gate latch for use with a gate includes a first handle for operating the gate latch from a first side of the gate; a second handle for operating the gate latch from a second side of the gate; a catch disposed between the first handle and the second handle; and, a biasing element operative to bias the catch toward engagement with a keeper to releasably retain the gate in a closed position.

In another embodiment, a gate latch for use with a gate having a free end mounted for swinging movement relative to a stationary post includes a keeper member configured to be secured on the post; and a latch member configured to be secured on the gate, the latch member comprising a catch disposed between a first and a second handle and adapted to engage the keeper to releasably retain the gate in a closed position.

### BRIEF DESCRIPTION OF THE DRAWINGS

FIG. 1 is a top view illustrating the latch according to one embodiment of the present invention where the moving member is not secured to the stationary member.

FIG. 2 is a top view illustrating the latch according to FIG. 1 where the moving member is secured to the stationary member and where the moving member is spaced from the stationary member.

FIG. 3 is a top view illustrating the latch according to FIG. 1 where the moving member is secured to the stationary member and where the moving member is spaced from the stationary member a distance greater than that illustrated in FIG. 2.

FIG. 4 is a perspective view of the catch assembly according to one embodiment of the present invention.

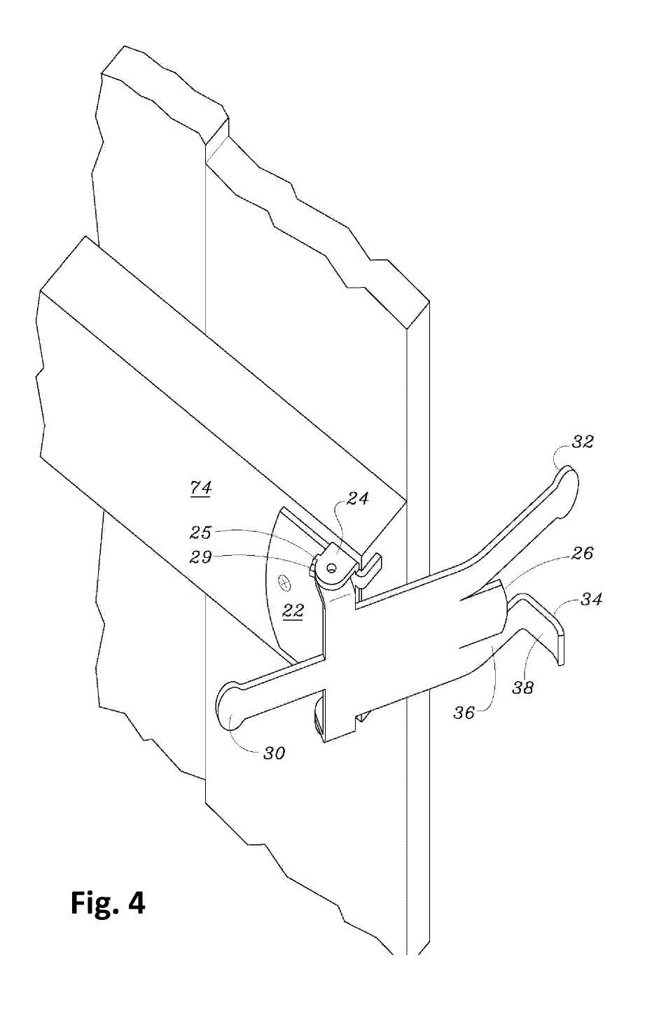

FIG. 5 is a front view of he catch assembly attached to a swingable member such as a swinging gate.

FIG. 6 is one embodiment of a keeper assembly adapted to be attached to a stationary member such as a post.

FIG. 7 is a top view of illustrating the catch assembly according to FIG. 1 where the keeper assembly is located on the stationary member at a location that is different than in FIG. 1.

### DETAILED DESCRIPTION

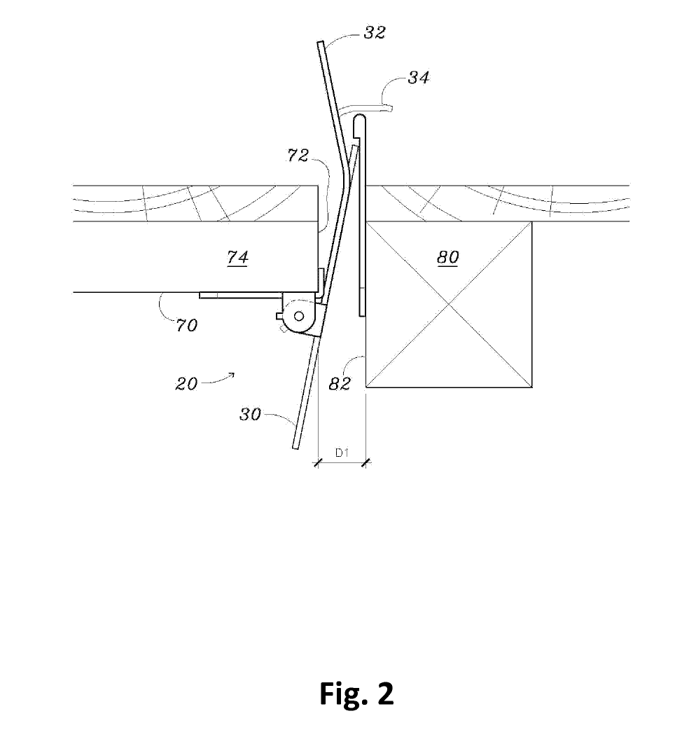

Turning now to the drawings, a latch generally designated by reference numeral 10 will be described. The latch 10 includes a catch assembly 20 that cooperates with and engages a keeper assembly 60 to releasably secure a moving member 70 such as agate to a stationary member 80 such as a post. The catch assembly 20 is secured to the free end of the moving member 70 and it is received by a keeper assembly 60 that is attached to a stationary member 80. When the moving member 70 is in a closed position with respect to the stationary member 80 (see FIG. 2), the catch assembly 20 is engaged with the keeper assembly 60. In this configuration, the moving member 70 has a first surface 72 opposite and spaced from a first surface 82 of the stationary member 80, as best seen in FIG. 2.

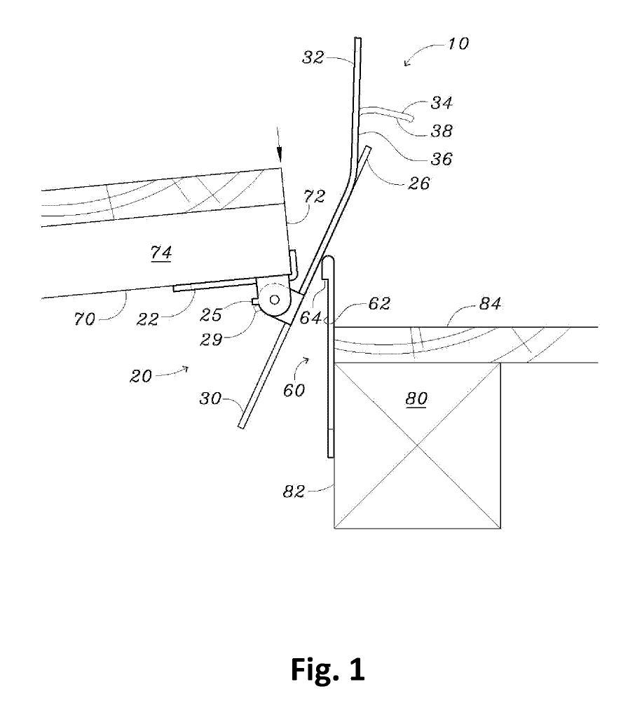

FIG. 1 shows a top view of the latch 10 according to one embodiment of the present invention. The latch 10 includes a catch assembly 20 that includes a mount 22 attached to a portion of the free end of the moving member 70. The mount 22 can be attached to a second surface 74 of the moving member 70. Generally, the second surface 74 will be substantially perpendicular to the first surface 72 of the moving member 70.

Of course, one skilled in the art will understand that although the free end of the moving member 70 is depicted in FIG. 1 as being generally rectilinear, the free and could be differently shaped. For example, the free end could be cylindrical, oval, or the like. In this instance, the mount 22 can be attached to a portion of the free end of the moving member 70 such that a tangent to the portion will be substantially perpendicular to a tangent of another portion of the free end that is opposed to the stationary member 80 when the moving member 70 is in a dosed position.

A catch 26 is pivotally retained on the mount 22 and is located between a first handle 30 and a second handle 32. When the moving member 70 is in a dosed position, the first handle 30 is on one side of the moving member 70 and the second handle 32 is on the other side of the moving member 70. As a result, a user is able to release the catch 26 from either side of the moving member 70 when the moving member 70 is in the closed position.

According to one embodiment, the catch 26 lies in substantially the same plane as the first handle 30. In one embodiment, the catch 26 can be formed as a plate with one end defining the first handle 30 and a portion of the other end defining the catch 26. The second handle 32 extends outwardly and away from the catch 26. In one embodiment, the second handle 32 extends in a direction away from the stationary member 80 when the moving member 70 is in the closed position. In other words, the second handle 32 extends from the catch 26 toward the moving member 70. The second handle 32 can extend away from the catch at an angle, which can be an acute angle.

The catch assembly 20 may include a stop 34 that extends toward the keeper assembly 60. As shown in FIG. 1, the stop 34 includes a first portion 36 that is parallel to the second handle 32 and a second portion 38 that extends at an angle from the first portion 36 toward the keeper assembly 60. The second portion 38 can extend at an angle that is substantially perpendicular to the first portion 36. The stop 34 is effective to limit the movement of the moving member 70 in the direction of travel toward the stationary member 80.

As shown in FIG. 2, as the moving member 70 moves toward the stationary member 80 and toward a closed position, the stop 34 may contact a portion of the keeper assembly 60 to limit further motion of the moving member 70 in the direction of travel, i.e., in the direction toward a closed position.

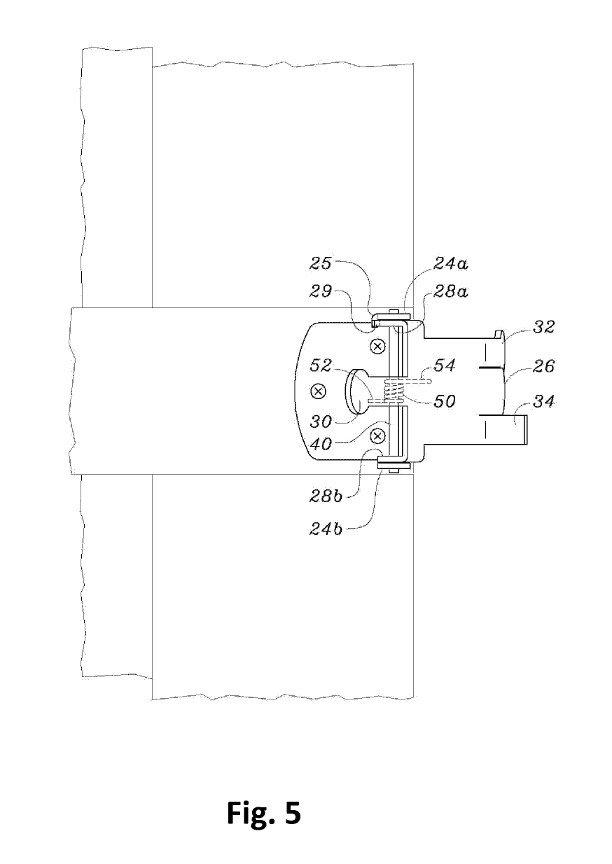

Turning to FIG. 5 where other features of the catch assembly are illustrated, in one embodiment, the catch mount 22 includes a pair of spaced apart lugs 24a, 24b that extend from the mount 22. The catch assembly 20 includes a pair of lugs 28a, 28b that cooperate with the mount lugs 24a, 24b to allow the catch 26 to pivot or rotate with respect to the mount 22. A pin 40 extends through holes provided in each of the lugs 24a, 24b, 28a, and 28b to retain the mount lugs 24a, 24b and the catch lugs 28a, 28b in a cooperative relationship with each other.

Mount lug 24a includes a mount stop tab 25 that extends from the mount lug 24a and cooperates with a catch stop tab 29 that extends from the catch lug 28a. Mount stop tab 29 includes a portion that extends toward lug 24b such that as the catch assembly 20 rotates, further rotation is inhibited by contact between catch stop tab 29 and mount stop tab 25. While the tabs 25 and 29 are illustrated and described as being located adjacent mount lug 24a and catch lug 28a, respectively, one skilled in the art would appreciate that they could likewise be provided adjacent mount lug 24b and catch lug 28b, respectively.

While the catch assembly 20 is shown as an integral unitary member, it is possible to form the catch assembly 20 from separate pieces. However, one skilled in the art will appreciate that it is likely advantageous to form the catch assembly 20 as a single integral unitary member.

The latch 10 includes a biasing member 50, best seen in FIG. 5, to bias the catch 26 away from the moving member 70 toward the keeper assembly 60. Referring back to FIG. 1, it will be appreciated that the biasing member 50 will bias the catch 26 in a direction away from the first surface 72 of the moving member 70.

The biasing member 50 can be any suitable spring such as a tension spring that will be operative to bias the catch toward the keeper assembly. FIG. 5 shows the biasing member 50 in the form of a tension spring that surrounds the pin 40 and has one end 52 in contact with the mount 22 and a second end 54 in contact with the catch 26.

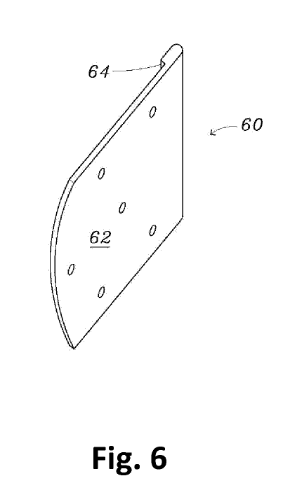

Referring back to FIG. 1, the keeper assembly 60 is mounted on the stationary member 80. In the embodiment shown in FIG. 1 and FIG. 6, the keeper assembly 60 includes a keeper mount plate 62 that is attached to the stationary member 80. The mount plate 62 can be attached to the first surface 82 of the stationary member 80. The keeper assembly 60 has a keeper 64 extending from the keeper mount plate 62 such that the keeper 64 is engaged by the catch 26 to releasably retain the moving member 70 in a closed position. As seen in FIG. 1, the keeper 64 extends in a direction away from the first surface 82 of the stationary member 80.

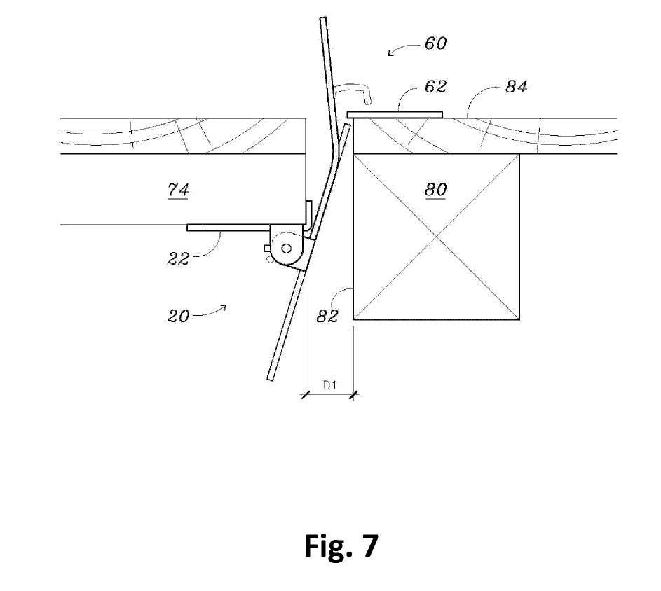

Turning to FIG. 7, another embodiment of the keeper assembly 60 is shown. In this embodiment, the mount plate 62 is attached to a second surface 84 of the stationary member 80, where the second surface 84 is substantially perpendicular to the first surface 82.

In operation, as the moving member 70 moves in a direction of travel depicted by the arrow in FIG. 1 toward a closed position, a portion of the catch assembly 20 will contact a portion of the keeper assembly 60. Further travel of the moving member 70 toward the closed position causes the stop member 34 to contact a portion of the keeper assembly 60 to retard further travel of the moving member 70. Because the catch 26 is biased away from the moving member 70, it will contact the keeper 64 to releasably secure the moving member 70 in a closed position with respect to the stationary member 80.

It will be appreciated that the moving member 70 may be provided with a biasing member (not shown) to bias the moving member 70 in a direction of travel toward the dosed position. As a result, the moving member 70 will be biased to move toward the closed position and be releasably secured to the stationary member 80 by virtue of the latch 10.

To release the catch 26 from the keeper 64, a user may move either the first handle 30 or second handle 32 in the appropriate direction so that the catch 26 is moved toward the moving member 70 to disengage the catch 26 from the keeper 64. Advantageously, the latch 10 of the present invention provides a handle 30, 32 on both sides of the moving member 70 so that the catch 26 can be released from the keeper 64 from either side of the moving member 70 when the moving member is in a closed position. After the catch 26 is disengaged from the keeper 64, the moving member 70 can then be moved away from the closed position.

Referring to FIG. 2, the gap or distance between the moving member 70 and the stationary member 80 when the moving member 70 is in the closed position is shown as D1. The distance D1 can vary depending on a variety of factors, including but not limited to location requirements, environmental conditions, and other factors. It will be appreciated that because of the unique design of the catch 26 of the present invention, a wide variety of gaps or distances between the moving member 70 and the stationary member 80 can be easily accommodated by the latch 10 so that the moving member 70 can be releasably secured to the stationary member 80. For example, the gap or distance DI may range from about 1 cm to about 100 cm or from about 1 cm to about 50 cm or from about 1 cm to about 30 cm or from about 1 cm to about any integer from 2 to 30 cm. Of course, the wider the gap the less effective the gate may be to retain animals etc. from passing through the gap.

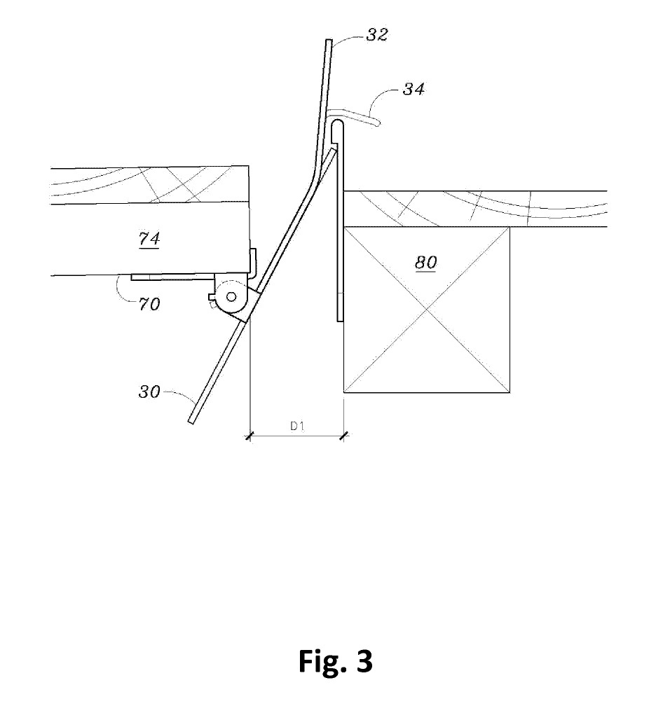

Advantageously, a single size latch 10 can accommodate a wide variety of distances or gaps. In this regard, FIG. 2 shows a catch assembly 20 that has a length L defined as the distance from the end of the catch 26 to the end of the first handle 30. The gap or distance D1 in FIG. 2 may be, for example, about 1 cm. With the same size catch assembly 20, i.e., a catch assembly 20 having a length L that is the same length as in FIG. 2 the moving member 70 can be releasably secured to the stationary member 80 when the gap or distance D1 is, for example, about 6 cm, as illustrated in FIG. 3. Of course, one skilled in the art will appreciate that the recited gap distances are merely exemplary.

In addition, not only can the latch can accommodate varying gaps (i.e., horizontal distances), both initially and after installation due to, e.g., environmental conditions, but the latch can accommodate vertical changes between the moving member and the stationary member caused by, e.g., environmental or other factors. As a result, after installation of the latch the need to periodically adjust the latch is reduced or even obviated.

Although the preferred embodiments of the present invention have been described, those skilled in the art can make additional changes and modifications to these embodiments once learning the basic inventive concepts thereof. Therefore, the appended claims are intended to be interpreted as including the preferred embodiments as well as all changes and modifications that fall into the scope of the present application.

Obviously, those skilled in the art can make various modifications and variations to the present application without departing from the spirit and scope thereof. Thus, if these modifications and variations of the present application are within the scope of the claims of the invention as well as their equivalents, the present application is also intended to include these modifications and variations.

1. A latch for first and second members, where the first member is stationary and the second member rotates about an axis toward the first member to a closed position and away from the first member to an open position, the first member having a first surface and the second member having a first surface, which is opposed to and spaced from the first surface of the first member when the first and second members are in a closed position, the latch comprising:
a keeper assembly mounted on the first member and including a keeper;
a catch assembly pivotably mounted on the second member and including a catch wherein when the second member rotates about the axis toward the first member, the catch engages the keeper to releasably secure the first member to the second member.

2. The latch of claim 1 wherein the keeper assembly is mounted on the first surface of the first member.

3. The latch of claim 1 wherein the catch assembly is mounted normal to the first surface of the second member.

4. The latch of claim 1 wherein the catch is biased in a direction normal to the first surface of the second member.

5. A gate latch for use with a gate, the gate latch comprising:
a first handle for operating the gate latch from a first side of the gate;
a second handle for operating the gate latch from a second side of the gate;
a catch disposed between the first handle and the second handle; and,
a biasing element operative to bias the catch toward engagement with a keeper to releasably retain the gate in a closed position.

6. The gate latch of claim 5 wherein the gate latch is mounted on a swinging gate and the keeper is mounted on a stationary post.

7. A gate latch for use with a gate having a free end mounted for swinging movement relative to a stationary post comprising:
a keeper member configured to be secured on the post;
a latch member configured to be secured on the gate, the latch member comprising a catch disposed between a first and a second handle and adapted to engage the keeper to releasably retain the gate in a closed position.
